(19) United States
(12) Patent Application Publication
(10) Pub. No.: US 2007/0266191 A1
(43) Pub. Date: Nov. 15, 2007

(54) Method and system for context sensitive presenting of traffic announcements

(75) Inventors: Dietmar Schnepp, Willich (DE); Thomas Hinzmann, Viersen (DE); Robin Most, Ratingen (DE)

Correspondence Address: Hollingsworth & Funk, LLC;Suite 125, 8009 34th Avenue South,, Minneapolis, MN, 55425, US

(73) Assignee: Nokia Corporation

(21) Appl. No.: 11/431,841

(22) Filed: May 10, 2006

(30) Foreign Application Priority Data
May 20, 2005 (IB) PCT/IB05/01372

(51) Int. Cl. G06F 13/26

(52) U.S. Cl. 710/264; 455/227

(57) ABSTRACT

A method and device for context sensitive presenting of traffic announcements within a car audio system with navigation and/or telecommunication functionality. The method comprises receiving a traffic announcement, detecting if said output device is currently used for performing output, and in case the output device is used storing said traffic announcement for later output, or in case the output device is not used outputting said traffic announcement through said output device. The device comprises a navigation and/or telecommunication component providing a navigation and/or telecommunication functionality, respectively, a receiver adapted for receiving traffic announcements, at least one output device adapted for outputting navigation output of said navigation component, telecommunication output of said telecommunication component or audio output of said car audio system, a storage component adapted for storing traffic announcements, and a controller connected to said storage component, said receiver and said navigation and/or telecommunication component.

### FIELD OF THE INVENTION

The present invention relates to presenting traffic announcements in car audio systems with communication and/or navigation functionality. It particularly relates to a context sensitive recording and play back of traffic announcements in such systems. The invention is intended especially for devices using audio/voice output.

### BACKGROUND OF THE INVENTION

Communication functionality in the context of the invention is a technology that offers the driver the possibility to make or receive phone calls, e.g. with a phone engine that is incorporated in a car radio, or with a hands free functionality built into the car radio wherein the mobile phone is connected to the car radio via a cable or a wireless link. Navigation technology in this context is either a navigation system built into the car radio or a navigation system that is connected to the car radio via a cable or a wireless link.

Communication functionality is a feature that has become very popular recently. Being able to drive a vehicle while at the same time making or receiving phone calls, wherein the driver has both hands free for operating the vehicle, greatly enhances comfort and provides for improved driving safety.

Another feature that just recently has become more widely used in cars is the navigation functionality, e.g. a GPS based navigation system for directing a driver to a desired destination.

Both communication and navigation systems can advantageously be integrated into the cars audio system. Thus the display of the audio system can be used to display maps, text messages and the like, while the speakers of the audio system can be used to play back navigation instructions or for voice output of a telephone call.

A feature being present in car audio systems for a long time is the possibility to receive traffic announcements, e.g. information about road blockages, traffic jams and other traffic-related information. When the driver is listening to a CD with the cars audio system it is known to interrupt such audio output for outputting traffic announcements which are received by the systems FM tuner that operates in a background mode. A CD will be paused while the traffic announcement message is put out through the loudspeakers.

However this feature is not fully operational in conjunction with the above mentioned communication and/or navigation features. Interrupting the playback of a music CD for outputting traffic announcements does not entail any problem, as such CD playback is of low priority compared to being informed that the road the driver follows is blocked nearby or the like. Thus such interruption will easily be accepted in order to be informed at the earliest possible time.

The situation is fundamentally different with the communication and/or navigation systems. A user will not accept to be interrupted by traffic announcements when being in a telephone call. Even worse, if such interruption would be performed like with the CD when navigation instructions are played back (“turn left on next crossing” or similar) the driver would not be able to follow the guidance instructions of the navigation system. Missing a particular exit or the like would be considered unacceptable.

On the other hand, if traffic announcements are not presented to the driver because of an ongoing phone call or because navigation instructions are given, the chance increases that important traffic-related information will be missed. As such traffic announcements are usually presented about once or twice an hour the driver may already be stuck in a traffic jam when he is able to hear the next traffic announcement referring to this traffic jam if earlier announcements are dropped because of the above mentioned reasons.

Using the communication and/or navigation functionality might therefore lead to a situation where the driver misses traffic announcements. In case of an acoustical traffic announcement it will be missed because the audio is used for call and/or acoustical navigation system output and therefore the acoustic traffic information is muted. In case of the announcement being in visual form (e.g. text-based) it might not be shown because the display is used for other purposes in case of call and/or navigation (map with direction arrows being displayed or the like).

The functionality to record traffic announcements is available in some car radios, however the playback has to be triggered manually so far. It can thus not be ensured that no important traffic messages are missed in case the user forgets to trigger the playback after ending a call or the like.

Therefore it is apparent that there is a need for a method and a system for automatic context sensitive presenting of traffic announcements, so that it can be assured traffic announcements are presented at the earliest occasion while at the same time more important outputs are not interrupted.

### SUMMARY OF THE INVENTION

The invention fulfills these and other objects by automatically recording traffic announcements and presenting, displaying or playing it back automatically depending on the communication and/or navigation functionality used by the user.

According to a first aspect of the invention a method for context sensitive outputting of traffic announcements with a car audio system is provided, where the car audio system is provided with navigation and/or telecommunication functionality, and where the audio system is able to receive the traffic announcements and includes at least one output device. One embodiment of the method includes at least receiving a traffic announcement, detecting if the output device is currently used for performing output, where if the output device is used storing the traffic announcement for later output, and if the output device is not used outputting the traffic announcement through the output device.

A method according to the invention ensures that traffic announcements or messages are presented to a user as soon as possible, so that no important traffic information is missed, while at the same time no other outputs occupying the output device will be interrupted. Important outputs in this context may e.g. be an ongoing telephone call, an output of driving instructions or a conversation via “push to talk”. The artisan will be aware of similar reasons for postponing outputting a traffic message, which are also within the scope of the present invention. Under special circumstances even outputs which may otherwise be considered having a low priority might be a reason for postponing the output, e.g. the user is listening to some radio play/drama that is not to be interrupted (imagine missing the essential scene in some thriller or murder story), over analogue FM radio as well as digital radio (like Digital Radio Mondiale DRM).

In an exemplary embodiment the detecting step is repeated in pre-determined intervals in case the output device is used. That is a way which is easy to implement, for detecting when the output device becomes unused again.

In an exemplary embodiment the detecting step comprises receiving an indication indicating if the output device is used or not. This enables e.g. an implementation wherein a telephone application/component sets a flag (“output device busy” or like) indicating the output device is not to be used for low priority outputs during an ongoing call. If it is detected that this flag is unset/not set anymore it can be concluded that the output device is available now. This is just an example of using an approach making use of flags; the artisan will be familiar with similar approaches following the same principle, like providing the flag vice versa only in case the output device is not used etc.

On the other hand this embodiment also enables a kind of “passive” mode, i.e. wherein the traffic announcement application/component does not actively check the status of the output device, but the telephone application can actively inform the traffic announcement application if the output device becomes unused again, after ending a telephone call.

The former implementation, i.e. performing regular checks, is very easy to implement, but might lead to a short delay for outputting the traffic announcement, depending on the check interval. The latter implementation, while being at least slightly more complicated, ensures that traffic announcements are presented as early as possible.

In one exemplary embodiment the traffic announcement is stored subsequent to the reception. In another exemplary embodiment the traffic announcement is stored if the output device is used.

The above described two exemplary embodiments provided different advantages, respectively. Always storing the traffic message immediately after reception is a simple implementation that simplifies the method of the invention. However it can also be advantageous to store the message only in case it can not be outputted immediately, to save storage space for example.

In an exemplary embodiment the method further includes determining a time span required for outputting said traffic announcement, where the detecting step further includes determining if the output device will not be used for at least that time span, concluding that the output device is not used responsive to a positive determination, and concluding that the output device is used responsive to a negative determination.

This embodiment is particularly useful in conjunction with navigation systems. Driving instructions of a navigation system are commonly outputted in a discontinuous manner, i.e. with breaks in between. The frequency and length of such breaks will depend mainly on the driving situation, e.g. while driving on highways driving instructions will occur far less often compared to driving in a town. If in the latter case driving instructions are outputted at a high frequency and with only short breaks in between it might not be suitable to start outputting traffic announcements immediately when the output device becomes unused (during one of the aforementioned breaks).

Therefore in this embodiment the time span required for outputting a particular traffic message is determined and compared to the expected break length. In case the break length is too short to allow for an output of the traffic message the output is further delayed, for example using the aforementioned “output device busy” flag. If however the time span is sufficient to perform the output of the traffic message the output is initiated. This implementation of the present invention provides for optimal presentation of traffic announcements using the available output time intervals.

In an even more sophisticated implementation the navigation system could also calculate, in case output of the traffic announcement is delayed due to insufficient break length, when a sufficiently long break is to be expected and signal this to a traffic announcement output application/component to enable it to schedule output accordingly.

In an exemplary embodiment the output is one of telecommunication output of the telecommunication function; navigation output of the navigation function; and audio output of the car audio system.

In an exemplary embodiment a low priority is assigned to audio output, and a high priority is assigned to telecommunication or navigation output, and the detecting step further comprises, in case the output device is used,
determining a priority of the currently performed output; and
if the priority is low
   interrupting the output such that the output device is not being used;
if the priority is high
   concluding that the output device is used;
      and further comprising
resuming the interrupted output subsequent to outputting the traffic announcement.

This provides for an improvement of the above described method, as the traffic announcements can be presented to the user even if an output (of lower priority) is currently performed. The user will thus be informed earlier in case a not so important output is occupying the output device.

In an exemplary embodiment the method further includes detecting, while outputting the traffic announcement, if an output of high priority is to be performed using the output device; interrupting outputting the traffic announcement for performing the output of high priority; and resuming outputting the traffic announcement.

This is necessary to ensure that even while traffic announcements are being outputted, important outputs like navigation instructions or an incoming call are presented to the user. If such important outputs are to be performed, outputting the traffic announcement can be interrupted. It is within the context of this invention to continue outputting the traffic messages where they were interrupted, as well as completely restarting such output. The latter can be advantageous to get the full information rather than just continuing.

In an exemplary embodiment the output device is one of a display device; and an audio output device; wherein the traffic announcement is output by displaying on the display device and/or by playing back through the audio output device. It is also within the context of this invention to choose between one of those two output devices (if two are present), if only one of them is not available. Thus during an ongoing call which occupies the loudspeakers, a display may still be used to present traffic messages in text form, or vice versa in case of driving instructions from the navigation system are being displayed in graphical form.

According to a second aspect of the invention a car audio system for context sensitive outputting of traffic announcements is provided, the audio system comprising
a navigation and/or telecommunication component providing a navigation and/or telecommunication functionality, respectively;
a receiver adapted for receiving traffic announcements;
at least one output device adapted for outputting navigation output of the navigation component, telecommunication output of the telecommunication component or audio of the car audio system;
a storage component adapted for storing traffic announcements;
a controller connected to the storage component, the receiver and the navigation and/or telecommunication component, and adapted for
   detecting if the output device is currently used for performing output; and
   if the output device is used
      storing said traffic announcement for later output; and
   if the output device is not used
      outputting the traffic announcement using the output device.

This provides a device being enabled to perform the method of the present invention. It is within the scope of the present invention to have both external components for telecommunication and/or navigation that are connected to the car radio or like, as well as having one or both of that components integrated into the car radio.

In an exemplary embodiment a low priority is assigned to audio output, and a high priority is assigned to telecommunication and navigation output, and wherein the controller is further adapted for
determining the priority of a currently performed output; and
if the priority is low
   interrupting the output and initiating outputting the traffic announcement;
if the priority is high
   concluding that the output device is used; and
resuming the interrupted output subsequent to outputting the traffic announcement.

In an exemplary embodiment the controller is further adapted for
detecting, while outputting the traffic announcement, if an output of high priority is to be performed;
interrupting outputting the traffic announcement for performing the output of high priority; and
resuming outputting the traffic announcement.

In an exemplary embodiment the controller is further adapted for
determining a time span required for outputting said traffic announcement; and
determining if the output device will not be used for at least said time span;
   wherein the controller concludes that the output device is not used responsive to a positive determination; and
   the controller concludes that the output device is used responsive to a negative determination.

In an exemplary embodiment the output device is one of
a display device; and
an audio output device.

The advantages of these embodiments have already been illustrated above when describing the method of the present invention.

In an exemplary embodiment the receiver is an FM radio receiver. FM radio in connection with the known functionality of RDS and similar systems provides for a very compatible and easy to use implementation of the present invention.

Today the user has the possibility to receive traffic messages and have them presented in different ways, which could be for example:

One way is to use the Traffic Message Channel (TMC) via RDS FM radio channel (detailed explanation about TMC is available e.g. on the internet). With the TMC system traffic messages are submitted to the car system and saved there. The system displays received traffic messages immediately or, with a voice synthesis system, the messages can be announced by voice to the driver. The primary intention of TMC is usage by a car navigation system for traffic dependent route guidance. However drivers do not use the route guidance system for standard routes (e.g. daily commuting from home to work and back) and therefore can not use the TMC message system.

Or the car radio can be tuned to a channel with regular traffic message announcements. The driver hears the traffic messages and then makes a decision to follow the planned route or to take an alternative route. A disadvantage of this system is, that the traffic messages might be outdated if presented only twice per hour. If the driver is engaged in a telephone call (where car radio is muted in state of the art systems) the driver will not be aware of incoming traffic messages.

All state of the art systems do not deal with the problem that a driver might miss traffic messages while being engaged in a phone call or while route guidance messages are announced by a car navigation system, i.e. when the audio system is used for other purposes of higher priority. The same is also true for route guidance messages being displayed on a display device inside the car, which prevents traffic announcements from being presented on that display.

In that context the problem the present invention is intended to solve is to take care that traffic messages are announced to the driver at the earliest possibility even when the driver is engaged in a phone call or when a route guidance system outputs route guidance information.

### BRIEF DESCRIPTION OF THE DRAWINGS

The invention will be illustrated in more detail in the following description of preferred embodiments, with reference to the attached drawings which are solely provided as illustrative but non-limiting examples, and wherein:

FIG. 1 is a flow diagram of an embodiment of the method according to the invention;

FIG. 2 is a flow diagram of an advanced embodiment of the method according to the invention; and

FIG. 3 schematically shows components of the system according to the invention.

### DETAILED DESCRIPTION OF ILLUSTRATED EMBODIMENTS OF THE INVENTION

Using the communication and/or navigation functionality of a car radio system can lead to a situation where the driver misses traffic announcements. In case of acoustical traffic announcements those will be missed because the audio is used for call and/or acoustical navigation system output and therefore the acoustic traffic information is muted. If the traffic info is in visual form (e.g. text based) it is not shown because the display might used for other purposes in case of on ongoing call and/or navigation maps/instructions being displayed.

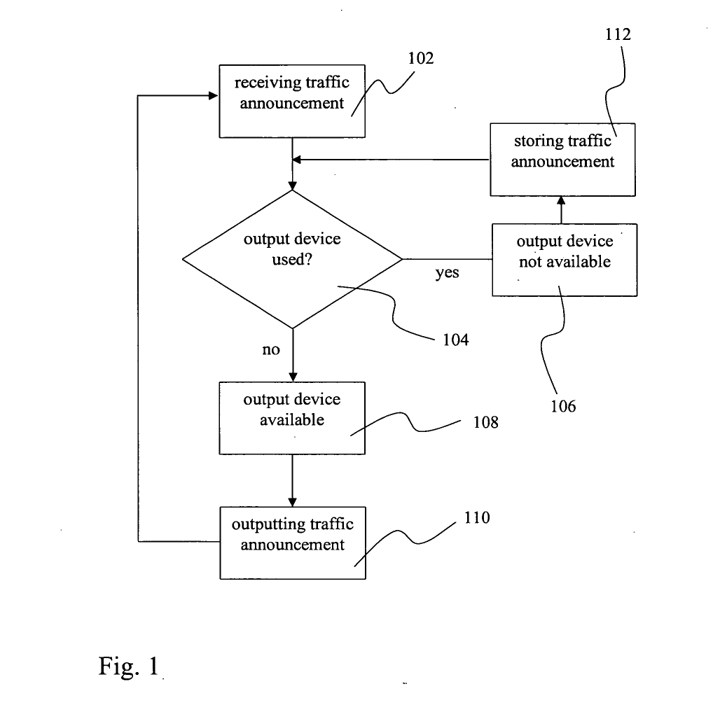

In FIG. 1 the basic steps of the method of the invention are shown. In step 102 a traffic announcement is received. This will usually be an FM radio traffic message; however the invention is not limited to that. Other reception channels are also possible, and also both in audio and in text form. In step 104 it is detected if the output device is currently used for performing an output. In case that the output device is used (step 106) the traffic announcement is stored in step 112, and the sequence returns to step 104. If or when, respectively, the output device is not used (anymore) it is concluded that the output device is available (step 108). The traffic announcement is output in step 110 and the sequence returns to the beginning, i.e. until the net traffic announcement is received.

It should be noted that, instead of the sequence described here it is also possible to store the traffic announcement immediately after reception. This may be advantageous e.g. if the output device is available, the traffic message is thus outputted, but the user is distracted otherwise while listening to the traffic message (some traffic condition requiring the full attention of the driver or like). If storing is performed directly after receiving a traffic announcement it is always available for being repeated later on, for example in the case just described (some distraction not affecting to the output device but the user's attention).

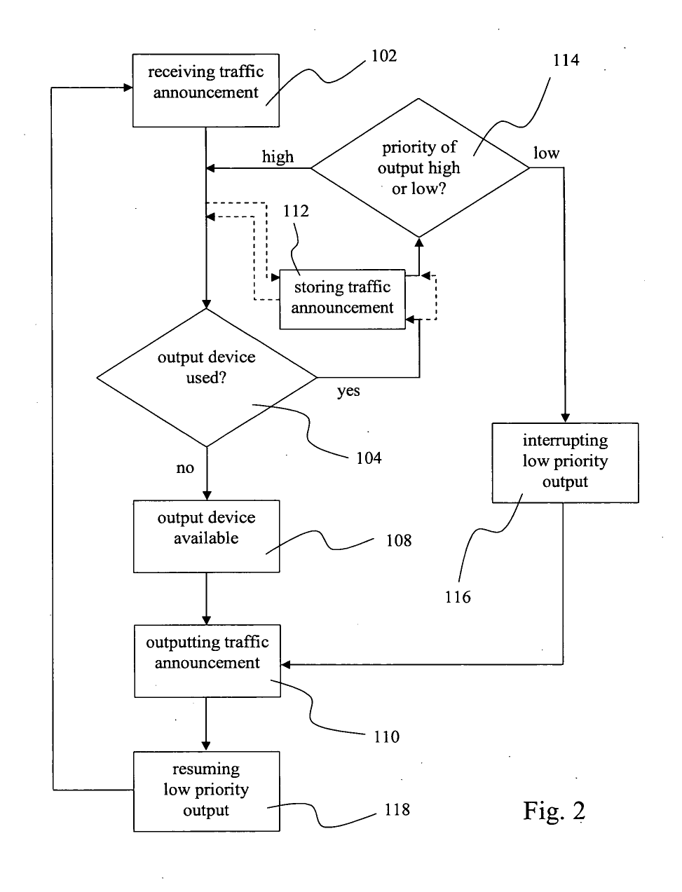

FIG. 2 shows a more advanced embodiment of the inventive method. Similar to the one depicted in FIG. 1 the method starts when a traffic message is received (step 102). In a possible embodiment the traffic message is then stored in step 112 (possibility indicated by the dashed arrows). Again, in step 104, it is detected if the output device is currently used for performing an output. If the output device is available the method is continued similarly to FIG. 1, with steps 108 and 110. If not, the traffic message may (in an alternative to performing step 112 after reception as described above) be stored responsive to the output device being busy. In both alternatives of storing the traffic message an additional step 114 is then performed, to detect, if the output occupying the output device is of high or of low priority. In case of a high priority output being performed the method returns to step 104. It should be readily apparent that in this case (high priority output preventing immediate output of the traffic message) the storing step 112 is not performed again if the output device is still busy during the further process, as it was already stored before (this being indicated by the dashed arrow by-passing step 112). In case of a low priority output being detected in step 114 the low priority output is interrupted in step 116 and the method continues with step 110. After outputting the traffic message is completed an interrupted low priority output, if present, is resumed.

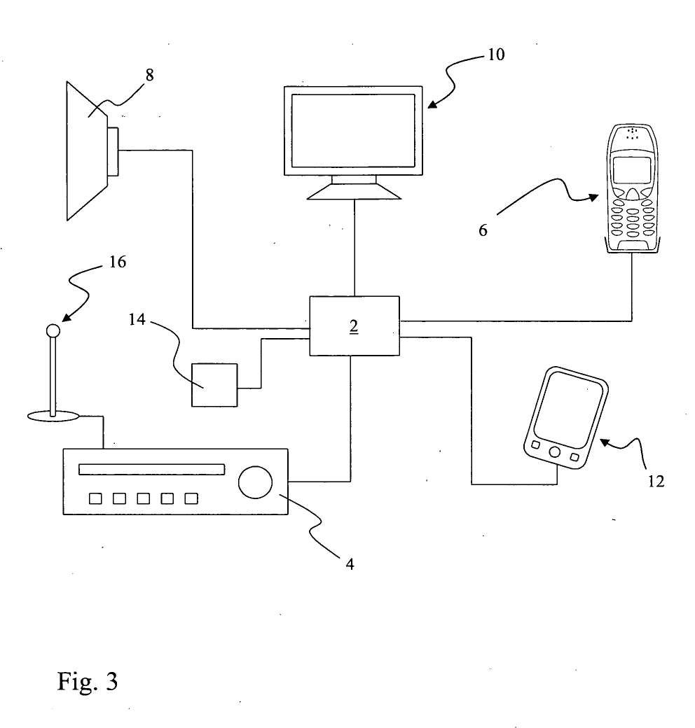

FIG. 3 shows components of a system of the invention. An exemplary car audio system 4 is shown, connected to a conventional FM radio antenna 16 for receiving FM radio traffic announcements. The audio system 4 is connected to the main controller 2 of the inventive system. The controller 2 is connected with a storage device 14 for storing or buffering traffic announcements. Controller 2 is further connected to a telecommunication component 6 and a navigation component 12. It has to be noted that the telecommunication component 6 in form of a mobile phone with suitable cradle and the navigation component 12 in form of a handheld computer are depicted here only in a symbolical manner. In the inventive system it is possible to have only either of those components or both together. Also those components can be “external” components connected to the system by a wired or a wireless link (cable, Bluetooth etc.), or they can be a(n) integral component(s) of a car audio system. The controller 2 further connects to a display device 10, which can be a display screen of the navigation component or also the display of the audio system 4 (not shown here). A loudspeaker 8 is connected the controller 2, which is usually to be understood as being a symbolical indication of the whole loudspeaker system installed a car.

The loudspeaker 8 and the display device 10 constitute two output devices, for outputting audio output and visual output, respectively. The controller 2 is adapted to control the reception, storage and presenting of traffic announcements according to the method of the invention. It is therefore able to detect if the output device(s) is/are occupied, when a traffic announcement comes in, and store the traffic announcement when required. The controller 2 is further adapted, in a more advanced embodiment, to detect if a currently performed output is of high or of low priority. High priority output like call-related voice output or navigation instructions given by the navigation component are not to be interrupted to present traffic message to the user. However low priority outputs like audio output from the car radio is to be interrupted for that purpose. The controller 2 can be adapted to detect, while a traffic message is being outputted, if another output is to be performed. Such might be the next guidance information (“turn left on next crossing”), an incoming phone call or the like. In case such high priority output shall be outputted while a traffic message is played back this will be interrupted to play back/display the more important driving instruction first. The interrupted low priority output can then be resumed (radio program) or restarted (music CD track).

In case the traffic announcements are broadcasted via a radio station and the driver is in a situation when he/she is not able to notice the traffic announcements he/she misses that information. Those situations might be for example having a call and/or using the navigation system in conjunction with acoustical output. Therefore a situation may occur where there are a lot of driving advices only interrupted by short breaks between them, when the navigation system is used e.g. while driving in a city, where lot of turns are necessary in short time spans.

If a driver uses the communication/navigation functionality while a traffic announcement is broadcasted (e.g. via voice or data) this traffic information is recorded automatically by the present invention. It is then played back automatically depending on the communication/navigation usage. The traffic information is presented to the user immediately when it is detected that no other output with higher priority is currently performed, e.g. subsequent to ending an ongoing telephone call or after an important driving advice was issued by the cars navigation system. While this automatic presentation is of course most preferred implementation the play back may additionally also manually be triggered and repeated.

In the following two exemplary use cases will be illustrated:

1) Communication

Here it is assumed that the driver is engaged in an ongoing call while a traffic announcement is broadcasted, i.e. the driver is using the hands free functionality of the car audio system. The traffic information is then recorded automatically, as the loudspeakers are occupied by the call-related voice output, thus preventing a play back of the traffic message. Once the call is terminated it will be detected that the loudspeaker serving as output device is no longer occupied, and the recorded information is played back automatically.

2) Navigation

Assuming there is a navigation advice being output to the driver while a traffic announcement is broadcasted by a radio station. As the output device (display screen for visual driving instructions or loudspeaker for audible instructions) is not available for the traffic announcement it will be recorded automatically. The playback of the recorded traffic announcement(s) is triggered depending on the navigation system output state.

There are several ways of triggering possible. Two examples can be explained as follows:
A partial play back could be performed during the navigation output breaks, i.e. between two successive driving advices. “Partial” in this context means that single traffic announcements, e.g. referring to different highways, are played back one by one, if there is more than one traffic message stored.
Playback occurring as a whole, depending on the estimated pause length between two consecutive navigation advices. Estimating the pause length is done automatically based on navigation information, speed of the car, etc.

As there seems to be a correlation between the importance of traffic information for a trip and the amount of navigation advices, the inventive system and method may also make use of the kind of route the driver is actually following, through a connection with the navigation component.

E.g. driving in a city will mean many navigation advices, however traffic information is less important, so delaying the playback is not so critical. On the other hand driving on a motorway means less navigation advices, however traffic information are very important here. Thus delaying the playback should be kept as short as possible. The inventive system could thus recognize these different conditions of the navigation system and handle delaying of the playback accordingly.

Two exemplary usage scenarios in this context shall be explained:

First Scenario: Active Phone Call

In case of an active phone call the telephone (application) might block the output channel for traffic messages by setting a flag indicating that the output channel can not be used for low priority outputs. Once the phone call is ended the “phone application” can inform the “traffic message application” application actively about that the traffic messages can be outputted now. It is also possible that the traffic message application itself checks if the phone call is ended so that traffic announcement can be outputted.

Second Scenario: Navigation System Active

This situation can be slightly more complicated. There may be enough time between two route guidance message outputs in order to output traffic messages. However in case of route guidance in a town (or other situation with many driving advices) there may only be a few seconds between successive route guidance messages, so that it is not practical to start traffic message output during such short intervals, as the next route guidance instruction (because of higher priority) will interrupt the traffic message output. So the navigation system might release the output device for traffic message output only if there is enough time between successive traffic messages for outputting.

In a further, even more sophisticated embodiment the traffic announcement system might indicate the time that is needed for traffic message output and this time can be utilized to decide if the traffic message can be outputted between successive route guidance messages and the traffic message application can then be informed accordingly. It may even be informed how long the traffic message application will have to wait until it can start the traffic message output, by determining when a break of sufficient length is about to occur.

What is claimed is:

1. Method for context sensitive outputting of traffic announcements with a car audio system provided with navigation and/or telecommunication functionality, said audio system being able to receive said traffic announcements and comprising at least one output device, the method comprising:
receiving a traffic announcement;
detecting if said output device is currently used for performing output; and
in case the output device is used, storing said traffic announcement for later output;
in case the output device is not used, outputting said traffic announcement through said output device.

2. Method according to claim 1, wherein said detecting step is repeated in pre-determined intervals in case the output device is used.

3. Method according to claim 2, wherein said detecting step comprises receiving an indication indicating if the output device is used or is not used, respectively.

4. Method according to claim 1, wherein said detecting step comprises receiving an indication indicating if the output device is used or is not used, respectively.

5. Method according to claim 1, further comprising:
determining a time span required for outputting said traffic announcement; and wherein said detecting step comprises:
determining if the output device will not be used for at least said time span;
concluding that the output device is not used responsive to a positive determination; and
concluding that the output device is used responsive to a negative determination.

6. Method according to claim 1, wherein said output is one of:
telecommunication output of said telecommunication function;
navigation output of said navigation function; and
audio output of said car audio system.

7. Method according to claim 6, wherein a low priority is assigned to audio output, and a high priority is assigned to telecommunication or navigation output, and wherein said detecting step further comprises, in case the output device is used,
determining a priority of the currently performed output; and
if the priority is low, interrupting said output such that said output device is not being used;
if the priority is high, concluding that the output device is used;
and further comprising
resuming the interrupted output subsequent to outputting said traffic announcement.

8. Method according to claim 7, further comprising:
detecting, while outputting said traffic announcement, if an output of high priority is to be performed using said output device;
interrupting outputting said traffic announcement for performing said output of high priority; and
resuming outputting said traffic announcement.

9. Method according to claim 1, wherein said output device is one of
a display device; and
an audio output device; and
wherein said traffic announcement is output by displaying on said display device and/or by playing back through said audio output device.

10. Car audio system for context sensitive outputting of traffic announcements, comprising:
a navigation and/or telecommunication component providing a navigation and/or telecommunication functionality, respectively;
a receiver adapted for receiving traffic announcements;
at least one output device adapted for outputting navigation output of said navigation component, telecommunication output of said telecommunication component or audio of said car audio system;
a storage component adapted for storing traffic announcements;
a controller connected to said storage component, said receiver and said navigation and/or telecommunication component, and adapted for
detecting if said output device is currently used for performing output; and
in case the output device is used
storing said traffic announcement for later output; and
in case the output device is not used
outputting said traffic announcement using said output device.

11. Device according to claim 10, wherein a low priority is assigned to audio output, and a high priority is assigned to telecommunication and navigation output, and wherein said controller is further adapted for
determining the priority of a currently performed output; and
if the priority is low
interrupting said output and initiating outputting said traffic announcement;
if the priority is high
concluding that the output device is used; and
resuming the interrupted output subsequent to outputting said traffic announcement.

12. Device according to claim 11, wherein said controller is further adapted for
detecting, while outputting said traffic announcement, if an output of high priority is to be performed;
interrupting outputting said traffic announcement for performing said output of high priority; and
resuming outputting said traffic announcement.

13. Device according to claim 10, wherein said controller is further adapted for
determining a time span required for outputting said traffic announcement; and
determining if the output device will not be used for at least said time span;
wherein the controller concludes that the output device is not used responsive to a positive determination; and
the controller concludes that the output device is used responsive to a negative determination.

14. Device according to claim 10, wherein said output device is one of
a display device; and
an audio output device.

15. Device according to claim 10, wherein said receiver is an FM radio receiver.
